(19) United States
(12) Patent Application Publication
(10) Pub. No.: US 2008/0231885 A1
(43) Pub. Date: Sep. 25, 2008

(54) DIRECT PRINTING METHOD USING RAM STORAGE FOR SPOOLED PRINTER FILES

(75) Inventors: Duc Phu Truong, West Covina, CA (US); Kenneth David Hayber, Fountain Valley, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 11/690,648

(22) Filed: Mar. 23, 2007

(51) Int. Cl. G06F 3/12

(52) U.S. Cl. 358/1.15; 358/1.16

(57) ABSTRACT

In a PDF direct printing method, the printer controller stores PDF direct print data received from a client on a RAM of the printer controller, or partly on the RAM according to a printing order and/or frequency of use if there is insufficient space to stored all the received PDF data. A PDF parser on the client generates a tag for each block of data being transferred based on the content of the block, and transfers the tag with the block. Based on the tag, the printer controller stores each block either on RAM or on disk. The printer controller maintains a memory allocation database to record the memory location where each block is stored on the printer controller. During rendering, the database is accessed to determine the memory location for blocks of data, and the blocks are retrieved from the memory locations for processing.

### BACKGROUND OF THE INVENTION

1. Field of the Invention

This invention relates to direct printing of a file of a certain description language, such as a PDF file, and in particular, it relates to a PDF direct printing method and apparatus that uses RAM storage for spooled printer files.

2. Description of Related Art

A PDF (Portable Document Format) file contains a plurality of blocks of data (objects) which are either commands or resources. At the end of a PDF file is a cross-reference table (sometimes referred to as the directory information) that lists all of the resources and commands contained in the PDF file, specifying for each of them an offset value from the beginning of the PDF file which represents the location of the resource or command within the PDF file. When a command needs to use a resource, it refers to the cross-reference table to determine the location of the resource within the file. A resource may be referenced many times by different commands. A PDF file may logically contain a plurality of pages of data, each page including a plurality of blocks of data, but unlike in some other page description languages, data in a PDF file is physically organized in a random fashion rather than a linear fashion.

PDF direct printing is a process by which a PDF file is sent directly to a compatible printer device without first using an application or print driver to pre-process the PDF data into a traditional print language such as PDL (Page Description Language). In a conventional PDF direct printing method, after the PDF file is sent to the printer controller (which may reside either on a server connected to the printer, or on the printer as embedded controller), the printer controller saves the PDF file on a hard disk, and then accesses it using disk I/O functions during the rendering (interpretation) process. That is, the entire direct print PDF data is written in one single file on the hard disk. Rendering a PDF file this way is a disk I/O intensive process because unlike other PDL files, data is structured within a PDF file in a non-sequential order. Throughout the rendering process, the PDF file will be accessed in a non-sequential manner; therefore, it might take a relatively long time to retrieve data from the PDF file on the hard disk especially when the PDF file is large because many fseek's, an expensive disk operation, are required to retrieve non-sequential file data.

### SUMMARY

Accordingly, the present invention is directed to a method and apparatus for direct printing of PDF or other file that substantially obviates one or more of the problems due to limitations and disadvantages of the related art.

An object of the present invention is to reduce memory access time during the rendering process of PDF direct printing.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method in a data processing system for direct printing of a file, the file having a plurality of blocks of data, the data processing system including a printer controller and a client connected to each other, the printer controller having a first, random-access memory (RAM) and a second memory, the method including, on the client: (a) examining the file to generate metadata indicative of contents of blocks of data to be transferred; and (b) transferring blocks of data with associated metadata to the printer controller; on the printer controller, (c) receiving blocks of data with associated metadata from the client; (d) based on the associated metadata, storing each block of data either in the RAM or in the second memory; and (e) recording in a memory allocation database memory locations where each block is stored.

The metadata may include a tag associated with each block of data which includes information indicating a data type, size of the block, and offset of the block from a beginning of the file. The metadata may also include a resource usage reference table containing information indicating frequencies of use of the blocks of data within the file. In step (d), the blocks of data may be stored based on a page printing order and/or frequency of use of the blocks. The method may further include, on the printer controller, (f) accessing the memory allocation database to obtain the memory location for blocks of data needed for rendering; (g) retrieving the needed blocks of data from the respective memory location; and (h) processing the retrieved blocks of data to render an image.

In another aspect, the present invention provides computer program products that cause a data processing apparatus to perform the above methods.

In yet another aspect, the present invention provides a data processing system for direct printing of a file, the file having a plurality of blocks of data, the system comprising: a printer controller having a first, random-access memory (RAM) and a second memory; and a client connected to the printer controller, the client including a parser for examining the file to generate metadata indicative of contents of blocks of data to be transferred and for transferring blocks of data with associated metadata to the printer controller, wherein the printer controller further includes a preprocessor module for receiving the blocks of data transferred from the client and for storing each received block of data either in the RAM or in the second memory based on the associated metadata, the printer controller further including a memory allocation database for recording memory locations where each block of data received from the client is stored.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a client computer and printer controller system according to an embodiment of the present invention.

FIG. 2 illustrates a process by the client computer for transferring a direct print PDF file from the client to the printer controller according to an embodiment of the present invention.

FIG. 3 illustrates a process by the printer controller for receiving and storing the PDF direct print data transferred from the client computer according to an embodiment of the present invention.

FIG. 4 illustrates a process for rendering a direct print PDF file according to an embodiment of the present invention.

FIG. 5 illustrates a monitoring method during the rendering process for monitoring the RAM usage and transferring data from the disk to the RAM according to an embodiment of the present invention.

### DETAILED DESCRIPTION OF PREFERRED EMBODIMENTS

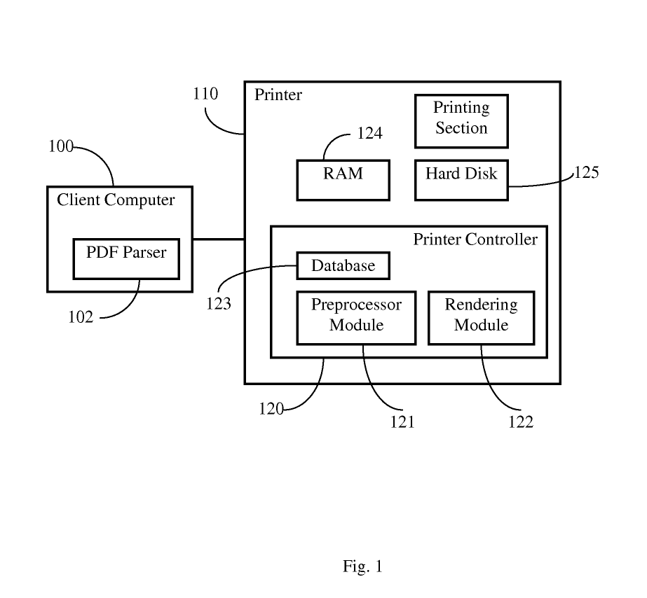

FIG. 1 schematically illustrates a system including a client computer 100 connected to a printer 110 on which methods according to embodiments of the present invention may be implemented. The client computer 100 includes a PDF parser 102 and the printer 110 includes a printer controller 120. In this embodiment each of the PDF parser 102 and the printer controller 120 is fully or partly implemented by a central processing unit (CPU) of the client computer 100 or the printer 100 executing a computer program stored in a storage device such as a read only memory ROM and a hard disk. Although in this figure the printer controller 120 is shown as residing on the printer 110, it may also reside on a server connected to the client computer and the printer (not shown). In this case, the printer controller 120 may be fully or partly implemented by a CPU of the server executing the computer program. The RAM 124 and the hard disk 125 are resources associated with the printer controller. The printer controller 120 includes a preprocessor module 121 that manages the print jobs, including performing the functions of spooling PDF direct print data from the client and storing the data on either the RAM 124 or the disk 125, a memory allocation database 123 maintained by the preprocessor module, and a rendering module 122 for interpreting the PDF direct data and performing other image rendering functions. While a hard disk is used as an example in this disclosure, the technique disclosed herein is applicable when other types of relatively slow storage devices, such as a flash drive, are used in conjunction with the RAM to store PDF direct print data on a printer controller.

Embodiments of the present invention employ a technique for storing PDF direct print files by the printer controller that reduces or eliminates the use of fseek( ) and other disk operations otherwise required to retrieve PDF data for the direct print job. Conventionally, the printer controller saves direct print PDF data by writing all data in one single file on the hard disk. To the contrary, the spooling algorithm according to embodiments of the present invention makes use of a reserved RAM (Random Access Memory) storage to store as much PDF data of the PDF direct print file as feasible. If all PDF data of the print job can be placed on the reserved RAM storage, then the printer controller will not have to perform any disk I/O to retrieve the PDF data during rendering. When the available memory in the reserved RAM storage cannot hold the entire PDF file, part of the data of the PDF file is stored on the reserved RAM and part of it is written to the hard disk as a file. In this case, embodiments of the present invention provide intelligent PDF data splitting algorithms which selectively store the PDF data on RAM based on various optimizing principles, such as storing PDF data that will be used earlier in the rendering process on RAM, or storing more frequently accessed portions of the PDF data on RAM and less frequently accessed data on disk, etc. The cross-reference table of the original PDF file is also transferred to the printer controller and is preferably stored in the RAM.

Regardless of the splitting algorithm used, the preprocessor module 121 maintains a memory allocation database 123 which records the memory location for each block of PDF direct print data stored either on the RAM 124 or on the disk 125. The blocks of data are identified in the memory allocation database by their offset values in the original PDF file. In this sense, the printer controller creates a “virtual” PDF file, where pieces of the PDF data are stored in various locations of the RAM or disk. When the rendering module 122 interprets the PDF direct print data, it looks up the memory allocation database 123 to determine the memory locations from which to retrieve the PDF data needed next for the rendering process. Because accessing a block of data on RAM is much faster than accessing a block of data on disk, storing all or part of the PDF data on RAM helps to reduce the time it takes to render a PDF direct print job.

A number of PDF data splitting algorithms may be used by the printer controller for storing the PDF direct print data on RAM or disk. In a simple case, the client computer 100 transfers the PDF direct print data sequentially according to the order the data is arranged in the original PDF file; the printer 110 stores the PDF data in the RAM 124 on a first-in basis until the RAM is full, and stores the rest of the PDF data on the disk 125. This approach is simple and easy to implement, but is disadvantageous when the page printing order for the print job (i.e. which pages of the PDF file are to be printed and in what order, including the ranges of the pages to be printed) is different from the page order of the original PDF file itself. For example, the print job may specify that only pages 10 and 3-5 of the PDF file are to be printed. According to the simple approach described above, the client computer 100 will transfer all pages starting from page 1. This results in unnecessary transfer of unused PDF data, as well as possibly causing some useful data (e.g. data for page 10) to be stored on the disk 125 while the RAM is filled with unused data.

More efficient PDF data splitting algorithms apply various rules when deciding how to split the PDF data on RAM and disk. A first rule, referred to here as the printing order rule, is to store blocks of PDF direct print data in the reserved RAM 124 according to the sequence in which the data will be used in rendering (i.e. the page printing order). Thus, data for pages that occur earlier in the printing order are store on RAM until the RAM is full, and the remaining pages are stored on the hard disk 125. This is advantageous because during rendering, after some pages are rendered, the printer controller will often be able to delete from the RAM some resources or commands for the already-printed pages that are no longer needed, thus making space available on RAM to store additional resources or commands for subsequent pages which have been stored on the disk.

A second rule, referred to here as the frequency of use rule, is to store blocks of PDF direct print data in the reserved RAM 124 or on the disk 125 based on the frequency the block of data will be used in the rendering process. More frequently used blocks of the PDF direct print data will be stored in the reserved RAM 124 and less frequently used blocks of data will be stored on the hard disk 125. For example, in a typical PDF file, some resources may be referenced many times throughout the PDF rendering (interpretation) process. An example of such resources is the font data embedded in the PDF file (also referred to as downloaded fonts). When the contents of a spooled PDF file have to be split and stored on RAM and disk, storing as many of such frequently used resources on RAM as possible helps to reduce the time required to access them.

The printing order rule and the frequency of use rule may be used in combination. For example, in a preferred PDF data splitting algorithm, PDF data are stored on RAM according to the page printing order as long as all data for the next page can be stored on RAM; when the available RAM is insufficient to store all resources and commands for a page, PDF data within that page is split between RAM and disk such that more frequently used blocks of data will be stored on RAM and less frequently used blocks of data will be stored on disk.

In a preferred embodiment, the PDF data splitting algorithms is implemented by providing an intelligent PDF parser 102 on the client computer 100 which cooperates with the preprocessor module 121 of the printer controller. At the beginning of the PDF direct print data transfer process, the preprocessor module 121 transfers to the PDF parser 102 the printing order information which specifies which pages of the PDF file are to be printed and in what order. Alternatively, the preprocessor module 121 may transfer a part of the printing order information, such as the order of the first few pages to be printed, to the parser 102 at the beginning, and continue to transfer the printing order information throughout the data transfer process. The PDF parser 102, which has knowledge of the structure of the PDF file, parses out and transfers PDF direct print data to the printer controller according to the printing order. For example, if the printing order specifies that pages 10 and 3-5 are to be printed in that order, then the PDF parser 102 will transfer the data used for pages 10 and 3-5 in that order, and will not transfer unnecessary data for other unprinted pages. The preprocessor module 121 stores the transferred data in the RAM 124 or the disk 125 based on a PDF data splitting algorithm.

The parser 102 adds metadata referred to as a tag to each block of the PDF data it transfers to the printer controller 110. Each tag preferably includes the following information: a data type identification (whether the data is a resource or a command), size in bytes (size of the block of data being transferred), and offset in bytes from beginning of the file (the location of the data in the original PDF file). As described in more detail later, the tag is used by the preprocessor module 121 of the printer controller 120 to determine where to store the block of data.

In addition to transferring a block of PDF data, the parser 102 also transfers a section of the cross-reference table of the PDF file related to the block of data. As mentioned earlier, each PDF file normally contains a cross-reference table at the end of the file that identifies all resources and commands in the PDF file and specify their offset value from the beginning of the file. The PDF parser 102 parses out the section of the cross-reference table relevant to the block of data being transferred, and transfers that parsed section of the cross-reference table to the printer controller. A tag, not to be confused with the tags associated with the blocks of PDF data, precedes the section of the cross-reference table to inform the printer controller of the nature of the data that follows. The section of the cross-reference table may be transferred either after or before the block of data itself. If the section of the cross-reference table is transferred before the block of data, the tag associated with the block of data may be simpler because some of the information (e.g. offset) is contained in the section of the cross-reference table which precedes the block of data. As another alternative, sections of the cross-reference table for all blocks of data for a page may be transferred together. The transfer sequence is not critical. As described in more detail later, the sections of the cross-reference table are stored by the printer controller to be used in rendering the PDF file.

When the frequency of use rule is implemented, the PDF parser 102 generates information indicating the frequency of use of each block of PDF data and transfers the frequency of use information to the printer controller. To determine the frequency of use of a certain resource within a given page, the PDF parser 102 examines all commands in that page to determine how many times the resource is used to render the page. Alternatively, and more preferably, the frequency of use information may indicate the number of times a resource is used within all of the pages to be printed. To accomplish this, the PDF parser 102 examines all of the pages to be printed (assuming the parser has received the complete printing order information from the printer controller) to determine the frequency of use for each resource. An advantage of this alternative is that it allows the rendering module 121, during rendering, to determine that a resource in RAM is no longer needed for rendering after the resource has been used by all the commands within the pages to be printed that are to reference to that resource, and to delete that resource from the RAM.

The frequency of use information is transferred to the printer controller in the form of a resource usage reference table, which lists all blocks of data (resources and commands) used within the pages to be printed and specifies their sizes, frequencies (the number of times) of use, which pages they are transferred in (as a resource may be used by many pages but will be transferred only once), etc. It also specifies the size of each page of data. The resource usage reference table is transferred before any PDF data is transferred. Alternatively, the frequency of use information may be organized into multiple resource usage reference tables each associated with a page of the PDF file, where the resource usage reference table associated with a page is transferred before the PDF data for that page. As described in more detail later, the resource usage reference table or tables are used by the printer controller to determine whether to store blocks of PDF data during data transfer.

The tags and the resource usage reference tables generated by the PDF parser 102 are utilized by the preprocessor 121 of the printer controller to determine where to store the blocks of PDF data. When a page of PDF data cannot be entirely stored in the RAM, the preprocessor module 121 determines which blocks with that page will be stored in the RAM based on frequency of use information in the resource usage reference table. For example, the preprocess module 121 may determine that a more frequently used resource is larger than the size of the remaining available RAM, in which case the preprocessor module 121 will decide to store a smaller, albeit less frequently used resource in the RAM. Or, the preprocess module 121 may determine that although a more frequently used, smaller resource will fit in the RAM, it will make the remaining RAM slightly too small for another much larger, albeit less frequently used resource, in which case the preprocessor module may decide to store the smaller, more frequently used resource on the disk and store the larger, less frequently used resource in the RAM. Having decided which resources of the next page will be stored in the RAM, the preprocessor module 121 can determine, as each block of data for that page is received, whether to store the block of data in the RAM or the disk.

Commonly owned, co-pending U.S. patent application Ser. No. 11/681,138, entitled “Non-Sequential Transfer of PDF Data for PDF Direct Printing,” describes a method of transferring PDF direct print data non-sequentially from a client computer to a printer controller. A PDF parser on a client computer is described therein that performs the PDF file transfer functions. The PDF parser 102 in embodiment of the present invention, while having certain features in common with the PDF parser described in application Ser. No. 11/681,138, is primarily useful in cooperation with the preprocessor module 121 on the printer controller to achieve split RAM/disk storage of PDF data.

In addition to splitting the PDF data on the RAM and disk during PDF data transfer, according to another aspect of the present invention, portions of the PDF data stored on the disk 125 may be moved to the reserved RAM 124 during the rendering process as space becomes available there. Space in the reserved RAM may become available under various conditions, including when an active PDF print job has been completely interpreted, and when some resource of the PDF file being interpreted is no longer needed and the rendering module 122 (the interpreter) can delete them from RAM to make room for new data. To accomplish this, the rendering module 122 monitors the reserved RAM 124 and if space becomes available there, it moves PDF data from the hard disk 125 to the RAM 124 and updates the memory allocation database 123 accordingly. The rendering module 122 determines which blocks of data to be moved from the disk to the RAM based on the same algorithm used previously to determine which PDF data to store on the RAM when receiving the data from the client. If the rendering process and the data moving process are executed by different threads, care must be taken to avoid moving any data that is currently being used for rendering or vice versa.

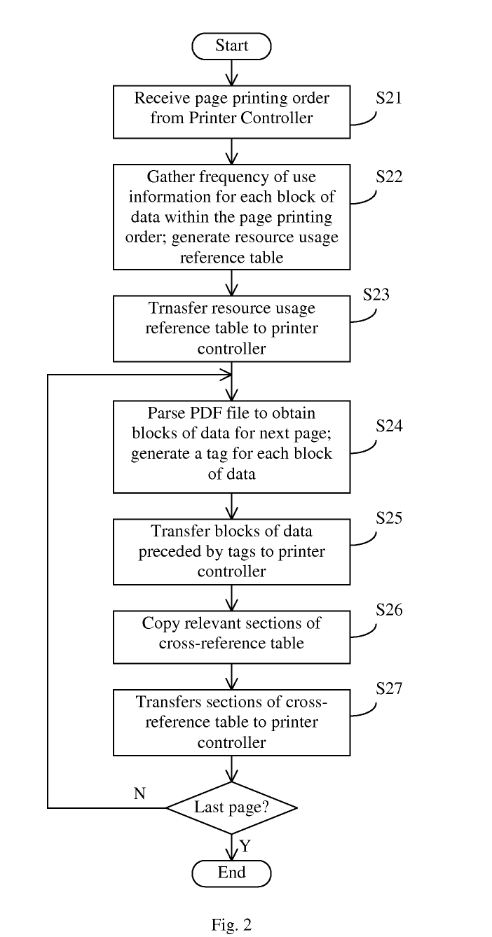

A PDF data transfer, storage and rendering process according to a preferred embodiment of the present invention is illustrated in more detail with reference to the flow charts in FIGS. 2-5. These flow charts illustrate an exemplary process, and many variations are possible based on the descriptions given in this disclosure. FIG. 2 illustrates a process executed by the PDF parser 102 on the client computer 100 for transferring pages of a direct print PDF file to the printer controller 120. As shown in FIG. 2, at the start of data transfer of a PDF direct print file, the parser 102 receives the page printing order from the printer controller (step S21). Based on the page printing order information, the parser iterates through the PDF file to determine which blocks of data are within the page printing order (i.e. to be transferred to the printer controller), gathers the frequency of use information for each such block of data, and generates a resource usage reference table (step S22). The resource usage reference table is transferred to the printer controller (step S23). The parser then parses the PDF file to obtain blocks of data for next page according to the printing order, and generates a tag for each block of data (step S24). The tag includes a data type identification, size in bytes, and offset in bytes from the beginning of the file. The blocks are transferred to the printer controller, each block being preceded with an associated tag (step S25). For each block of data transferred, the parser also copies the section of the cross-reference table of the PDF file related to the block (step S26), and transfers the sections of the cross-reference table to the printer controller (step S27). For simplicity, steps S24/S25 and S26/S27 are shown in FIG. 2 in a sequential order, but as pointed out earlier, the actual transfer sequence of the blocks of data for the page and the related section of cross-reference table is not critical as long as each block of data and each section of the cross-reference table is preceded with a tag to indicate what follows. Steps S24 to S27 are repeated until all pages within the printing order are transferred.

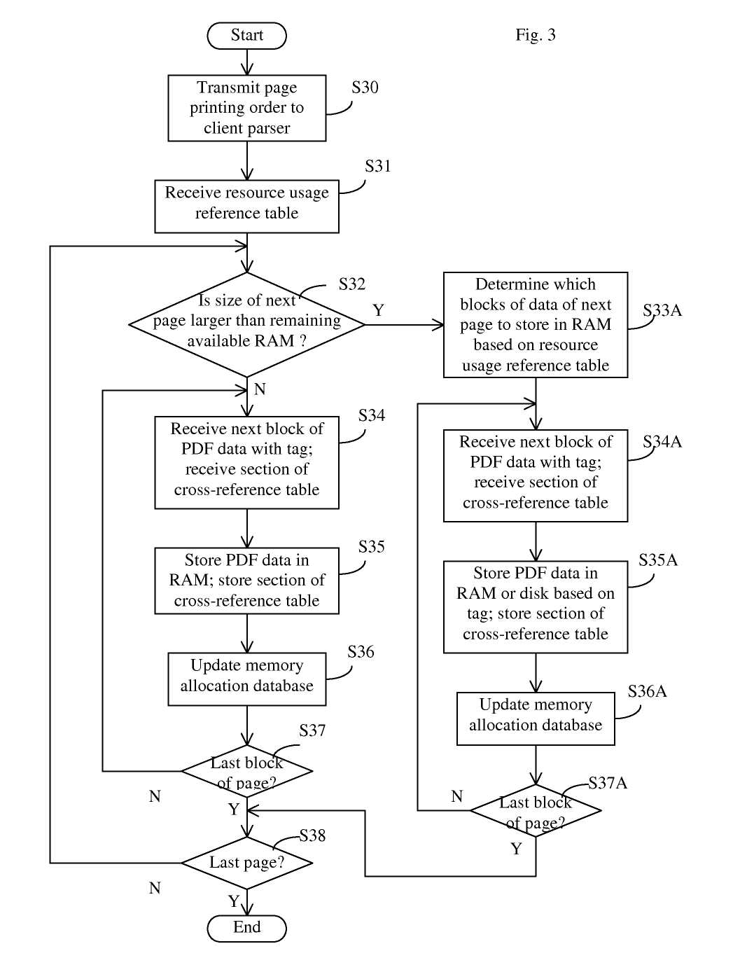

FIG. 3 illustrates a process executed by the preprocessor module 121 of the printer controller 120 for receiving and storing the PDF direct print data transferred from the client computer 100. As shown in FIG. 3, at the beginning of the PDF direct printing process, the preprocessor module 121 transmits information regarding the page printing order to the parser 102 on the client computer (step S30). As described in connection with FIG. 2, with the printing order information, the parser transfers to the printer controller the resource usage reference table, followed by blocks of PDF data according to the page order together with tags, as well as sections of the cross-reference table relevant to the blocks of data. Thus, in step S31, the preprocessor module receives the resource usage reference table and stores it locally (preferably in the RAM) for use during data transfer and rendering. Based on information in the resource usage reference table, the preprocessor module determines whether the total data size for the next page in the printing order is larger than the size of the remaining available RAM (step S32). If not (“N” in step S32), then all blocks of data for that page will be stored in the RAM. Thus, the preprocessor module receives from the client computer the next block of PDF data with the associated tag as well as the relevant section of the cross-reference table (step S34). The block of PDF data is stored in the RAM, and the section of the cross-reference table is also stored (step S35). The tag associated with that PDF data can then be discarded. The preprocessor module updates the memory allocation database 123 to record where the block of PDF is stored (step S36). Steps S34 to S36 are repeated until all blocks for that page of PDF data is received and stored (“Y” in step S37).

On the other hand, if in step S32 the preprocessor module determines that the size of the next page of PDF data is larger than the size of the remaining available RAM (“Y” in step S32), the preprocessor module examines the resource usage reference table to determine which blocks of data PDF for the next page will be stored in the RAM and which blocks will be stored on disk (step S33A). The preprocessor module receives from the client computer the next block of PDF data with the associated tag, as well as the relevant section of the cross-reference (step S34A). Based on the tag, the preprocessor module determines whether the block will be stored in the RAM or on the disk, and stores the data accordingly (step S35A). In step S35, the preprocessor module also stores the section of the cross-reference table. The preprocessor module updates the memory allocation database 123 to record where the block of PDF is stored (step S36A). Steps S34A to S37A are repeated until all blocks for that page of PDF data are received and stored (“Y” in step S37A).

Although not shown in FIG. 3 to avoid overcrowding, step S32 also determines whether the reserved RAM is full (i.e. no sufficient available space to store a block of data). If it is, then all subsequently received data will be stored on disk. The preprocessor module performs steps similar to steps S34 to S37 except the blocks of data are stored on disk rather than RAM.

The updating step S36 and S36A utilize the information contained in the tag for the block to update the memory allocation database. As described earlier, the memory allocation database 123 identifies each block of PDF data by its offset value in the original PDF file, and specifies the memory location (in RAM or disk) where the block of data is stored.

In steps S35 and S35A, the sections of the cross-reference table are stored either in the RAM or on the disk, preferably in the RAM as they will be referenced often during the rendering process. Preferably, all sections of the cross-reference table relevant to blocks of data within the printing order are stored together and form a new cross-reference table similar to the cross-reference table in the original PDF file except that it contains only sections that are relevant to blocks of data within the printing order. The memory location of the new cross-reference table may be recorded in the memory allocation database.

In the above-described embodiments, the PDF parser 102 generates a resource usage reference table and tags for each block of PDF data. More generally, the PDF parser 102 generates appropriate metadata indicative of contents of the PDF data being transferred, and the metadata is not limited to the specific form of resource usage reference tables and tags described above. The preprocessor module 121 examines the metadata when receiving the PDF data transferred from the parser 102.

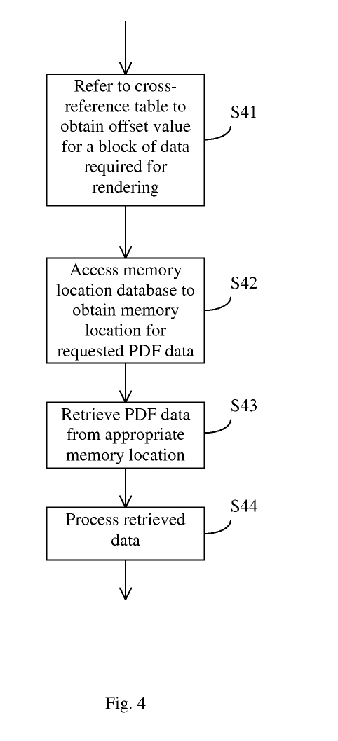

FIG. 4 illustrates a process executed by the rendering module 122 of the printer controller 120 for rendering a direct print PDF file. The blocks of data from the PDF file have been stored in the RAM and the disk, and a memory allocation database 123 has been established by the preprocessor module in the process shown in FIG. 3. A new cross-reference table has also been created as described above. The rendering process contain similar steps as conventional PDF rendering processes, such as converting the PDF data to PostScript (PS) data or other page description language (PDL) data, performing raster image processing (RIP) on the PS or PDL data to generate a bitmap image, etc. In a conventional rendering process, when a block of PDF data is needed for rendering, the rendering module refers to the cross-reference table to determine the location of the data within the PDF file. In the rendering process shown in FIG. 4, whenever the rendering module 122 needs a block of PDF data, either a resource or a command, it refers to the cross-reference table to obtain the offset value of the requested block of data (step S41). Then, the rendering module accesses the memory allocation database and, using the offset value which serves to identify the block of data, obtains the memory location of the block of data on the printer controller (step S42). The rendering module then retrieves the requested data from the appropriate memory location (step S43). The rendering module then processes the retrieved block of data (i.e. interpreting the commands or using the resources contained in the block) as in conventional renderers (step S44).

The rendering process may be implemented by modifying existing PDF rendering libraries. Current PDF rendering libraries assume that all resources/commands are in one single PDF file stored on disk, and uses disk operation such as fread ( ), fseek ( ) to access the resources and commands. The modified PDF rendering library according to embodiments of the present inventions replaces the disk operation by the steps S41 to S43 shown in FIG. 4.

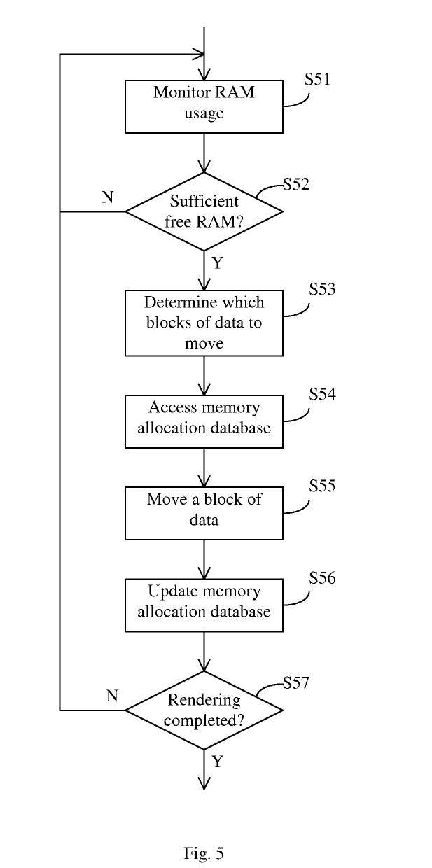

FIG. 5 illustrates a monitoring method executed by the rendering module 122 during the rendering process for monitoring the RAM usage and transferring data from the disk to the RAM. The rendering module monitors the RAM usage (step S51) to determine whether there is sufficient RAM available for moving one block (alternatively, on page) of data from the disk to the RAM. If there is sufficient RAM (“Y” in step S52), the rendering module determines which blocks should be moved from the disk to the RAM (step S53). In one embodiment where the rendering module moves one page of PDF data at a time, step S53 includes determining the next page of PDF data to move according to the printing order. In another embodiment where the rendering module moves one block of PDF data at a time (i.e. as soon as there is sufficient amount of free RAM for a block of data, even though there is insufficient amount of free RAM for a page of data), the rendering module uses the frequency of use rule described earlier to determine which block of data to move to the RAM. The rendering module then accesses the memory allocation database 123 to determine where the blocks to be moved are stored on the disk (step S54), and moves the blocks of data from the disk to the RAM (step S55). The rendering module updates the memory allocation database 123 by recording the new memory locations of the moved blocks (step S56). The rendering module continues to monitor the RAM until the rendering process is completed (step S57).

The rendering module 122 may also delete a resource from RAM after it has been used by all commands within the page printing order that are to use that resource. This is possible because the resource usage reference table indicates the total number of times each resource is used by all commands within the page printing order. The rendering module 122 keeps track of the number of use of each resource as the PDF data is rendered; for example, each time a resource is used, its number of use is decremented by 1 until it reaches zero indicating that the resource can be deleted.

An advantage of the PDF data splitting method and the memory allocation scheme according to embodiments of the present invention is improved speed of rendering PDF direct print jobs. Data access (read and write) from RAM is many times faster than from a hard disk. Therefore, storing data on RAM reduces the amount of the time required to transfer PDF data from the client computer to the printer controller. The retrieval of spooled PDF data by the rendering module is also faster if the PDF data resides on RAM instead of the hard disk. For very large print jobs, the amount of time saved by writing and reading data to and from RAM instead of to and from disk can be significant.

While one main feature of the present invention is storing PDF direct data on the RAM of the printer controller, splitting RAM and disk storage of PDF direct print data may be accomplished in a number of alternative ways. Some of the PDF data splitting algorithms are described above, and other variations are also possible. In addition, it is possible to implement the PDF data splitting method without using an intelligent PDF parser on the client computer. When the client computer is not equipped with an intelligent PDF parser, the preprocessor module will request the client computer to transfer the entire PDF file to the printer controller as in the conventional PDF direct printing method, then execute the PDF data splitting algorithm to move some of the PDF data to the RAM. In other words, the steps shown in FIG. 2 and FIG. 3 are combined and performed by the preprocessor module 121 of the printer controller. This alternative implementation has the disadvantage that, in the case where not all pages of the PDF file are to be printed, unused pages are transferred from the client to the printer controller. On the other hand, it has the advantage that the PDF data splitting method can be implemented by the printer controller alone even when the client is not equipped with an intelligent PDF parser. When a client parser 102 is used, the splitting process will take less time and the PDF rendering process can start as soon as some PDF data is received from the client parser, because the PDF data is being transferred by the client parser in a proper order. On the other hand, in the case where the rendering module is busy rendering a different job (rather than the PDF file that is being transferred, i.e. in a spooling mode), then the delay in starting the rendering process is of little consequence. When the rendering module is free and ready to render the spooled job, it is most likely that the preprocessor module has moved some of the PDF data of this spooled job to the RAM according to the intelligent PDF data splitting algorithm. Thus, in such a case, the PDF rendering performance can benefit from the RAM storage of the PDF data regardless of whether or not a client parser was involved.

Another variation of the printer-only implementation (i.e. a client parser is not present) is for the preprocessor module 121 to store the PDF data from the client on RAM first until the RAM is full, and store the rest of the PDF data on disk. Because the data received from the client did not take the page printing order into consideration, some unnecessary data for unprinted pages may be stored on RAM. Thus, the preprocessor modules 121 executes a second step process to move the PDF data between the RAM and the disk to achieve a more optimum storage using the PDF data splitting algorithms described earlier. For example, the preprocessor modules 121 may delete the unnecessary data that has been stored on RAM, and/or move some PDF data that has been store on RAM but will occur later in the page printing order, and move PDF data that has been stored on disk to the RAM once RAM space has been freed up.

As yet another alternative, the client computer may have a PDF parser that receives the printing order information from the printer controller and transfers the pages of the PDF file that will be printed without transferring all of the pages, but the parser on the client computer does not analyze the content of the PDF data to generate the frequency of use information. The preprocessor module, after receiving the pages of PDF data from the client, executes the PDF data splitting algorithm to move some of the PDF data to the RAM.

The implementation of the PDF data splitting method on the printer controller preferably takes advantage of the hardware capabilities of the computer that the printer controller is residing on. If the computer has a multi-core CPU architecture, one core can perform the monitoring and data moving task and another core can perform the rendering function. This design ensures that moving data from disk to RAM will not take CPU time away from the rendering module. On a single core CPU architecture, if the rendering module is waiting for the printing section to print a rendered image in the frame buffer, the printer controller can take advantage of the waiting time to perform the monitoring and data moving task.

Although direct printing of PDF documents are used as an example in the above descriptions, the method is not limited to PDF direct printing. The method can be applied to direct printing of other kinds of documents, especially the types of document that require an interpreter to access the document in a non-sequential fashion.

It will be apparent to those skilled in the art that various modification and variations can be made in the direct printing method and apparatus of the present invention without departing from the spirit or scope of the invention. Thus, it is intended that the present invention cover modifications and variations that come within the scope of the appended claims and their equivalents.

What is claimed is:

1. A method in a data processing system for direct printing of a file, the file having a plurality of blocks of data, the data processing system including a printer controller and a client connected to each other, the printer controller having a first, random-access memory (RAM) and a second memory, the method comprising:
on the client:
(a) examining the file to generate metadata indicative of contents of blocks of data to be transferred; and
(b) transferring blocks of data with associated metadata to the printer controller;
on the printer controller:
(c) receiving blocks of data with associated metadata from the client;
(d) based on the associated metadata, storing each block of data either in the RAM or in the second memory; and
(e) recording in a memory allocation database memory locations where each block is stored.

2. The method of claim 1, wherein the metadata includes a tag associated with each block of data being transferred, the tag including information indicating a data type, size of the block, and offset of the block from a beginning of the file.

3. The method of claim 1, wherein the metadata includes a resource usage reference table containing information indicating frequencies of use of the blocks of data within the file.

4. The method of claim 1, wherein the file includes a plurality of pages of data, each page including a plurality of blocks of data, the method further comprising:
the printer controller transmitting page printing order information to the client, the page printing order information indicating an order in which selected pages of the file are to be printed; and
wherein in step (b), the client transferring blocks of data to the printer controller based on the page printing order information, and
wherein in step (d), the blocks of data are stored in the RAM or the second memory based on the page printing order information such that blocks of data occurring earlier in the page printing order are stored in the RAM.

5. The method of claim 4, wherein the metadata includes a resource usage reference table containing information indicating frequencies of use of blocks of data within the file and a size of each page of data, and
wherein step (d) includes determining, for each page of the file within the page printing order, whether the size of the page is larger than a size of a remaining available space of the RAM, and if it is, storing the blocks of data for the page in the RAM or the second memory based on the frequencies of use of the blocks.

6. The method of claim 1, further comprising:
on the printer controller:
(f) accessing the memory allocation database to obtain the memory location for blocks of data needed for rendering;
(g) retrieving the needed blocks of data from the respective memory location; and
(h) processing the retrieved blocks of data to render an image.

7. The method of claim 6, further comprising:
monitoring availability of space in the RAM; and
when sufficient space is available, moving one or more blocks of stored data from the second memory to the RAM.

8. The method of claim 6, further comprising:
deleting from the RAM blocks of data that are no longer needed for rendering.

9. The method of claim 6, wherein the file contains a cross-reference table specifying an offset value for each block of data in the file, the method further comprising:
on the client:
(i) transferring to the printer controller sections of the cross-reference table relevant to blocks of data transferred in step (b);
on the printer controller:
(j) storing the sections of the cross-reference table transferred by the client to generate a new cross-reference table on the printer controller; and
(k) before step (f), referring to the new cross-reference table to obtain offset values for blocks of data needed for rendering;
wherein in step (f), the memory allocation database is accessed using the offset values obtained in step (k) to obtain the memory locations for the blocks of data.

10. The method of claim 1, wherein the file is a PDF (Portable Document Format) file.

11. A computer program product comprising a computer usable medium having a computer readable code embodied therein for controlling a printer controller used in a data processing system for direct printing of a file that has a plurality of blocks of data, the data processing system including the printer controller and a client connected to the printer controller, the printer controller having a first, random-access memory (RAM) and a second memory, the computer readable program code comprising code configured to cause the printer controller to execute a printer control process comprising the steps of:
(a) receiving blocks of data with associated metadata from the client, the metadata having been generated by the client and being indicative of content of the associated blocks of data;
(b) based on the associated metadata, storing each block of data either in the RAM or in the second memory; and
(c) recording in a memory allocation database memory locations where each block is stored.

12. The computer program product of claim 11, wherein the metadata includes a tag associated with each block of data received from the client, the tag including information indicating a data type, size of the block, and offset of the block from a beginning of the file.

13. The computer program product of claim 11, wherein the metadata includes a resource usage reference table containing information indicating frequencies of use of the blocks of data within the file.

14. The computer program product of claim 11, wherein the file includes a plurality of pages of data, each page including a plurality of blocks of data, the printer control process further comprising:
transmitting page printing order information to the client, the page printing order information indicating an order in which selected pages of the file are to be printed; and
wherein in step (a), the blocks of data have been transferred by the client based on the page printing order information, and
wherein in step (b), the blocks of data are stored in the RAM or the second memory based on the page printing order information such that blocks of data occurring earlier in the page printing order are stored in the RAM.

15. The computer program product of claim 14, wherein the metadata includes a resource usage reference table containing information indicating frequencies of use of blocks of data within the file and a size of each page of data, and
wherein step (b) includes determining, for each page of the file within the page printing order, whether the size of the page is larger than a size of a remaining available space of the RAM, and if it is, storing the blocks of data for the page in the RAM or the second memory based on the frequencies of use of the blocks.

16. The computer program product of claim 11, wherein the printer control process further comprises:
(d) accessing the memory allocation database to obtain the memory location for blocks of data needed for rendering;
(e) retrieving the needed blocks of data from the respective memory location; and
(f) processing the retrieved blocks of data to render an image.

17. The computer program product of claim 16, wherein the printer control process further comprises:
monitoring availability of space in the RAM; and
when sufficient space is available, moving one or more blocks of stored data from the second memory to the RAM.

18. The computer program product of claim 16, wherein the printer control process further comprises:
deleting from the RAM blocks of data that are no longer needed for rendering.

19. The computer program product of claim 16, wherein the file contains a cross-reference table specifying an offset value for each block of data in the file, and wherein the printer control process further comprises:
(g) receiving from the client sections of the cross-reference table relevant to blocks of data received in step (a);
(h) storing the received sections of the cross-reference table to generate a new cross-reference table on the printer controller; and
(i) before step (d), referring to the new cross-reference table to obtain offset values for blocks of data needed for rendering;
wherein in step (d), the memory allocation database is accessed using the offset values obtained in step (i) to obtain the memory locations for the blocks of data.

20. The computer program product of claim 11, wherein the file is a PDF (Portable Document Format) file.

21. A data processing system for direct printing of a file, the file having a plurality of blocks of data, the system comprising:
a printer controller having a first, random-access memory (RAM) and a second memory; and
a client connected to the printer controller, the client including a parser for examining the file to generate metadata indicative of contents of blocks of data to be transferred and for transferring blocks of data with associated metadata to the printer controller,
wherein the printer controller further includes a preprocessor module for receiving the blocks of data transferred from the client and for storing each received block of data either in the RAM or in the second memory based on the associated metadata, the printer controller further including a memory allocation database for recording memory locations where each block of data received from the client is stored.

22. The system of claim 21, wherein the metadata includes a tag associated with each block of data being transferred, the tag including information indicating a data type, size of the block, and offset of the block from a beginning of the file.

23. The system of claim 21, wherein the metadata includes a resource usage reference table containing information indicating frequencies of use of the blocks of data within the file.

24. The system of claim 21, wherein the file includes a plurality of pages of data, each page including a plurality of blocks of data,
wherein the preprocessor module transmits page printing order information to the client, the page printing order information indicating an order in which selected pages of the file are to be printed,
wherein the parser of the client transfers blocks of data to the printer controller based on the page printing order information, and
wherein the preprocessor module stores blocks of data in the RAM or the second memory based on the page printing order information such that blocks of data occurring earlier in the page printing order are stored in the RAM.

25. The system of claim 24, wherein the metadata includes a resource usage reference table containing information indicating frequencies of use of blocks of data within the file and a size of each page of data, and
wherein the preprocessor determines, for each page of data received from the client, whether the size of the page is larger than a size of a remaining available space of the RAM, and if it is, stores the blocks of data for the page in the RAM or the second memory based on the frequencies of use of the blocks.

26. The system of claim 21, wherein the printer controller further includes a rendering module for accessing the memory allocation database to obtain the memory location for blocks of data needed for rendering, for retrieving the needed blocks of data from the respective memory location, and for processing the retrieved blocks of data to render an image.

27. The system of claim 26, wherein the rendering module further monitors availability of space in the RAM, and when sufficient space is available, moves one or more blocks of stored data from the second memory to the RAM.

28. The system of claim 26, wherein the rendering module deletes from the RAM blocks of data that are no longer needed for rendering.

29. The system of claim 26, wherein the file contains a cross-reference table specifying an offset value for each block of data in the file,
wherein the parser transfers to the printer controller sections of the cross-reference table relevant to blocks of data transferred to the printer controller,
wherein the preprocessor module stores the sections of the cross-reference table transferred by the client to generate a new cross-reference table on the printer controller,
wherein the rendering module refers to the new cross-reference table to obtain offset values for blocks of data needed for rendering, and
wherein the rendering module accesses the memory allocation database using the offset values to obtain the memory locations for the needed blocks of data.

30. The system of claim 21, wherein the file is a PDF (Portable Document Format) file.

31. A method implemented on a printer controller for generating print data from a PDF file, comprising:
receiving the PDF file from a client, the PDF file including a plurality of blocks of PDF data;
storing a first sestet of blocks of PDF data in a first, random-access memory (RAM) and a second subset of blocks of PDF data in a second memory, the first subset of blocks being received from the client before the second subset of blocks;
transferring one or more blocks of the first subset of blocks of PDF data from the RAM to the second memory;
transferring one or more blocks of the second subset of blocks of PDF data from the second memory to the RAM; and
generating print data from blocks of PDF data stored in the RAM.
